(19) United States
(12) Patent Application Publication
(10) Pub. No.: US 2023/0400856 A1
(43) Pub. Date: Dec. 14, 2023

(54) AUTONOMOUS GUIDANCE THROUGH NARROW SPACES

(71) Applicants: Kristopher Douglas Rupay, Ottawa (CA); Arash Mahinakbarzadeh, Ottawa (CA); Payam Peter Bahraini, Ottawa (CA)

(72) Inventors: Kristopher Douglas Rupay, Ottawa (CA); Arash Mahinakbarzadeh, Ottawa (CA); Payam Peter Bahraini, Ottawa (CA)

(21) Appl. No.: 17/836,365

(22) Filed: Jun. 9, 2022

(51) Int. Cl. G05D 1/02

(52) U.S. Cl. CPC G05D 1/0212; G05D 1/0238

(57) ABSTRACT

The invention is an algorithm designed to be used with autonomous robots that are required to navigate through incredibly tight spaces such as aisles, hallways or even between two objects, where it must react and responds in real time with no previous knowledge of the surroundings.

Typically, navigation algorithms are designed for a known surrounding, by using maps or by creating a map dynamically by using distance-based sensors on board. This algorithm is designed to make real time movement decisions, with the goal to keep autonomous robots of interest centered between the narrow space (i.e., centered in an aisle or hallway).

### BACKGROUND

Autonomous movement often requires the use of maps or creating maps dynamically to perform navigation. This level of processing can be costly and time consuming.

Should the width of a known narrow space (i.e., aisle or hallway) is known, algorithms can easily be used to keep the autonomous robot centered and away from the walls or objects. If the width is changing or is unknown, this needs to be calculated dynamically in real time.

This algorithm has been designed to first detect the width of the space it is moving through, and then determine the adjustments required to keep the autonomous robot centered between the narrow space.

Should the narrow space shift (as an example—when an aircraft aisle transitions from three seats to four seats), the autonomous movement must automatically adjust and re-center itself in real time.

There are several parameters that can control the amplitude and the response of the adjustments, and will be different on each autonomous device, dependant on the weight, size, power of the motors, traction of the wheels (or tracks etc.), minimum buffer required to the edges, but these will quickly become fixed once determined for each device type using the algorithm.

### SUMMARY

This algorithm was designed for autonomous robots that need to move through narrow spaces quickly, dynamically, without previous knowledge of their surroundings or the width of the narrow spaces from either manual input or maps.

Distinguishing features of the algorithm include:
1) A three-step process to determine the required movement to center an autonomous robot between a narrow space.
2) A unique quadrant algorithm to calculate the approximate width of an aisle.
3) A combination of quadrant calculations to determine the total errors required to make the necessary adjustment.

### BRIEF DESCRIPTION OF DRAWINGS

FIG. 1: The three steps to determining the required autonomous adjustment.

FIG. 2: Birds eye view showing the four quadrants that start the calculation.

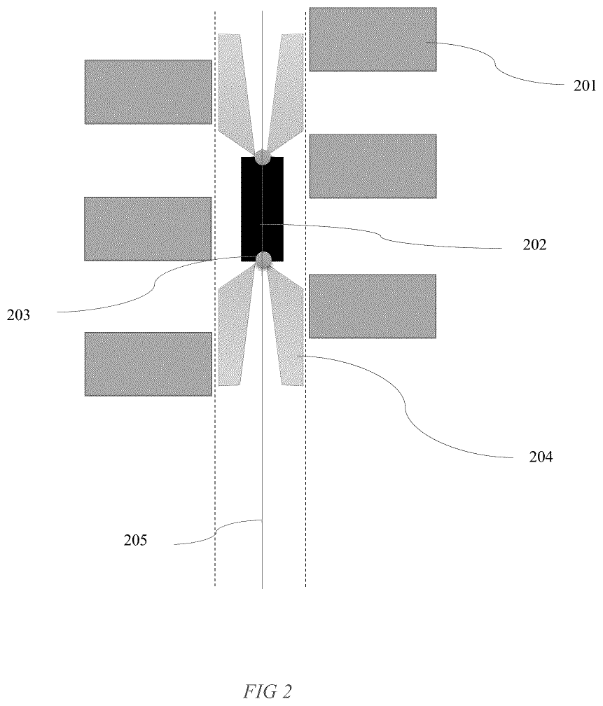

FIG. 3: The distance, widths and angles required to make the calculations.

FIG. 4: The equations used to calculate the total error required for autonomous adjustment.

FIG. 5: Incorporation of a PID control loop to smooth the error required for adjustment.

### DETAILED DESCRIPTION

This algorithm is used to navigate through narrow spaces, such as aisles and hallways without any prior knowledge of such space. The algorithm will keep the autonomous robot, centered between the narrowest position to the left and the narrowest position to the right of the robot.

Should the width of the narrow space change, the algorithm automatically adjusts. Should the width shift to the left or right, requiring a new center position, the algorithm will automatically adjust.

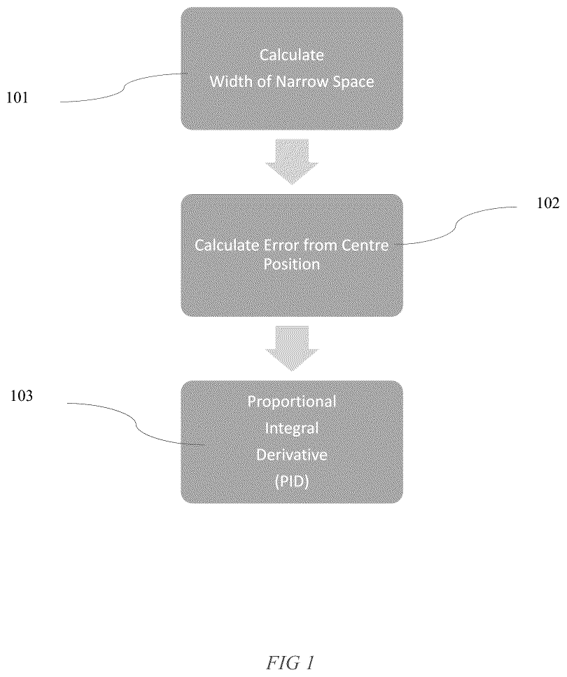

There are three parts to the algorithm, as shown in FIG. 1.
1. Calculate the width of the narrow space 101.
2. Calculate the error from the center position of the narrow space 102.
3. Smooth the algorithm, using a traditional PID (Proportional, Integral, Derivative) control loop 103.

The input to this algorithm, requires distance sensor 203 to the front and the rear of the device (or a single sensor that can detect both the front and rear) and must detect multiple distances and angles, ideally with a resolution of 1 degree or better.

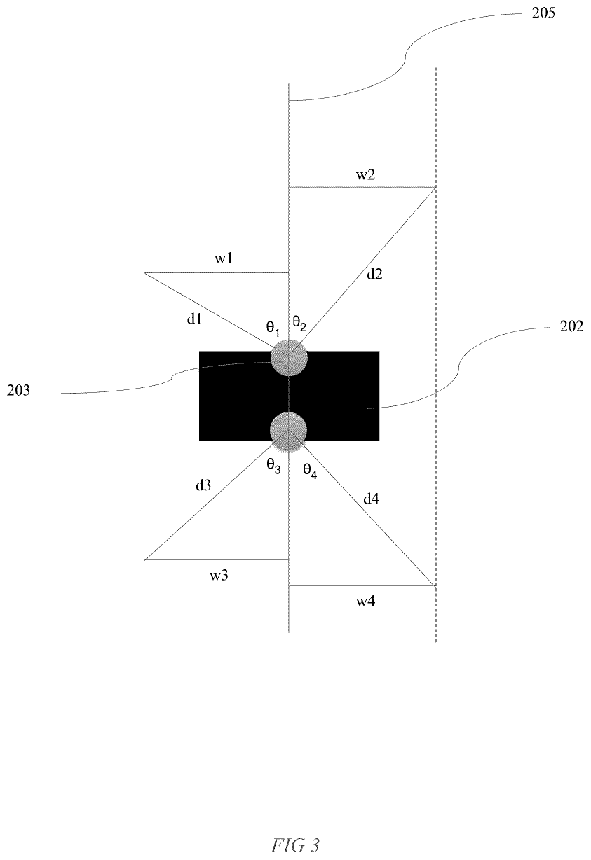

The distance readings of the sensors 203 are then divided in to four quadrants 204, that the algorithm will analysis. These distances are shown in FIG. 3 as d1, d2, d3 and d4. Although many distances will be received from the sensors, it is the shortest half width, denoted as w1, w2, w3 and w4 in FIG. 3, that is used to calculate the error. The half widths are the distance from any point on the side of the aisle to the center line 205 of the narrow space of interest.

At a very high rate (minimum of 5 Hz), the algorithm evaluates all distances and the respected angles, denoted as θ₁, θ₂, θ₃, and θ₄, and then calculates each half width, denoted as w1, w2, w3 and w4, to the center line ahead and behind of the autonomous robot using one of the Pythagorean theorem equations 401.

The shortest half width, w1, w2, w3 and w4 of each quadrant is then selected, and is considered as the closest object to the center line of the narrow space.

When the four half width's have been determined, an approximate aisle width can be calculated in the front using equation 402, and in the rear using equation 403.

To calculate a slightly more accurate calculation of the average width, the two aisle width calculations can be averaged together 404.

Again, using the four half widths w1, w2, w3 and w4, a calculation can be made to determine if the front and rear is biased to the left or right. The front is calculated by taking the difference between w1 and w2, and the rear is taken by calculating the difference between w4 and w3 as shown respectively in equations 405 and 406. Should the autonomous robot be closer to the right a positive value will result, and should it be closer to the left a negative result will result. This is true for both the front and the rear calculations of 405 and 406.

From these results, the following can then be determined:
1) Autonomous robot is ‘hugging’ closer to either the right side or the left side, denoted as Error_{HUG} and calculated in equation 407.
2) Autonomous robot is ‘twisted’ (i.e., the heading is not straight), denoted as Error_{TWIST} and calculated with equation 408.

If the error is zero in both equations 407 408, the robot is perfectly centered and not moving towards one side or the other of the narrow space. The goal of the algorithm is to maintain as close to error zero as possible.

These errors can equate to several different combination of scenarios where the robot may be twisted or hugging to the left or right side of the narrow space.

The total error (the final value that is used), is then a combination of the result of 407 and 408 denoted as equation 409.

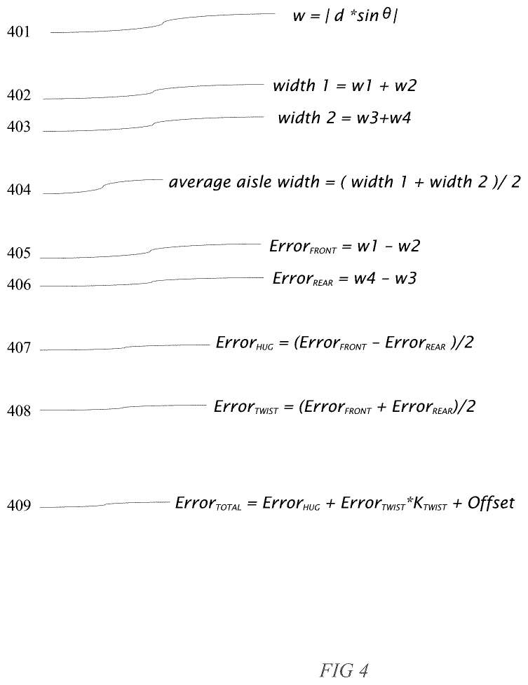

The errors are added together, but their relationship may not be equal. A heavy twist may require a larger response, then heavy hug, thus we introduce K_{TWIST} in FIG. 4, to be a configurable amplification (or de-amplification) when relating the hug and twist errors. Finally, should the robot need a slight adjustment (typically a sign that a mechanical alignment is required) to compensate for a mechanical biasness towards one side or the other, a configurable offset shown in equation 409 is added.

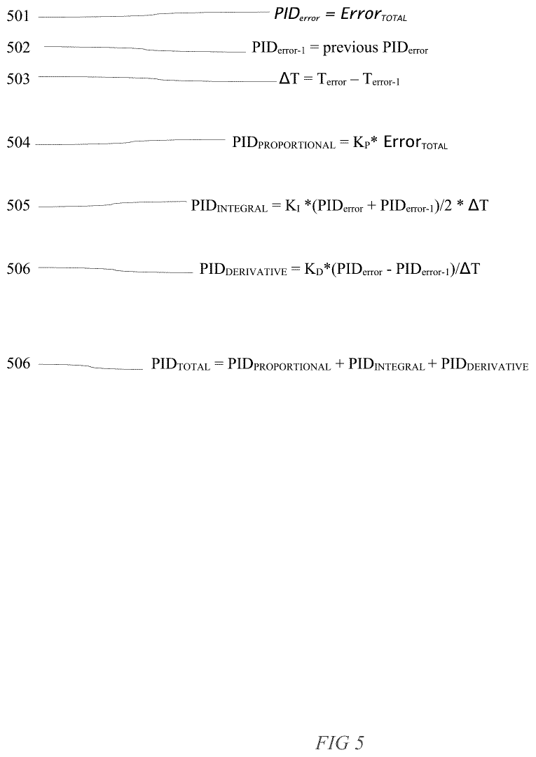

This total error then becomes the overall error that is fed directly into a PID Control Loop. The goal of the PID loop is to keep the error as close to zero as possible. The equations used for the PID control loop are shown in FIG. 5, but this is not a part of the invention specifically but is included as a part of the three-step process to ensure stable movement without oscillations.

With reference to the figures, the following table describes the elements within:

| | Name | Description |
|---|---|---|
| 101 | Width | A black box representing the width of the |
| | Calculation | narrow space. |
| 102 | Error | A black box representing the error calculation, |
| | Calculation | where error is a relative number with respect |
| | | to how far from the centre line the autonomous |
| | | mobile robot is positioned. |
| 103 | PID | A black box representing a PID controller loop |
| | Calculation | to smooth the error data. |
| 201 | Obstacle | Obstacles on either side of the autonomous |
| | | mobile robot, that define the narrow space to |
| | | move through. |
| 202 | Autonomous | The autonomous mobile robot that will move |
| | Mobile | through the narrow space. |
| | Robot | |
| 203 | Distance | A device that will detect many distances to the |
| | Sensor | 201 obstacles. |
| 204 | Quadrant | This represents 1 of 4 quadrants the device |
| | | scans many distances. |
| 205 | Centre Line | The goal of the algorithm is to keep the |
| | | autonomous mobile robot on the centre line. |
| 401 | Potential | This equation is used to determine the smallest |
| | Half Width | half width of each quadrant. |
| 402 | Front Width | Add the two lowest half widths together from |
| | | the front quadrants to calculate the total width |
| | | in front of the autonomous mobile robot. |
| 403 | Rear Width | Add the two lowest half widths together from |
| | | the rear quadrants to calculate the total width |
| | | behind the autonomous mobile robot. |
| 404 | Average | Calculate the average width between the front |
| | Width | and the rear. Note: The front width may be |
| | | different from the rear width if the aisle isn't |
| | | perfectly straight. |
| 405 | Front Error | Calculate how much closer is the front of the |
| | | autonomous mobile robot to one side or the other. |
| 406 | Rear Error | Calculate how much closer the rear of the auto- |
| | | nomous mobile robot is to one side or the other. |
| 407 | Hug Error | Calculate how much the autonomous mobile |
| | | robot is hugging to one side or the other. |
| 408 | Twist Error | Calculate how much the autonomous mobile |
| | | robot is twisted in the narrow space with |
| | | respect to the centre line. |
| 409 | Total Error | Combine the 407 Hug Error and the 408 Twist |
| | | Error together. |
| 501 | PID Error | Total Proportional Integral Derivative error. |
| 502 | Previous PID | Keep track of the previous 501 PID Error from |
| | Error | the previous cycle. |
| 503 | Rate | This is the time between update cycles. |
| 504 | Proportional | Calculate the present error. |
| | Error | |
| 505 | Integral Error | Calculate the predicted future error correction |
| | | required. |
| 506 | Derivative | Calculate and correct the past error. This will |
| | Error | control sudden changes. |

### ALTERNATE EMBODIMENTS

Future versions of the algorithm may be combined with other autonomous guidance algorithm to enable a complete guidance through any space. These algorithms could be a combination of real-time interpretation of surroundings or having advanced knowledge of the surroundings through exploration.

The invention claimed is:

1. An algorithm to keep an autonomous mobile robot centered down a narrow space, in real time, without any prior knowledge of its surroundings.

2. An algorithm to calculate the approximate width, relative left-right position, and the relative twist (rotation) of the autonomous mobile robot relative to the narrow space in real time.
